(19) United States
(12) Patent Application Publication
(10) Pub. No.: US 2026/0301278 A1
(43) Pub. Date: Oct. 1, 2026

(54) IMAGE GENERATION DEVICE, IMAGE GENERATION METHOD, AND IMAGE GENERATION PROGRAM

(71) Applicant: FUJIFILM Corporation, Tokyo (JP)

(72) Inventors: Keisuke YAMAKAWA, Kanagawa (JP); Isao TAKAHASHI, Kanagawa (JP); Wataru FUKUDA, Kanagawa (JP)

(73) Assignee: FUJIFILM Corporation, Tokyo (JP)

(21) Appl. No.: 19/558,530

(22) Filed: Mar. 6, 2026

(30) Foreign Application Priority Data
Mar. 26, 2025 (JP) 2025-052704

(51) Int. Cl. G06T 12/30; G06T 12/20

(52) U.S. Cl. CPC G06T 12/30; G06T 12/20; G06T 2210/41; G06T 2211/441; G06T 2211/448

(57) ABSTRACT

A processor is configured to: acquire a simulated projection image that simulates a projection image acquired by imaging a subject including a high-absorption object using a CT apparatus; estimate a scattered ray component representing a scattered ray amount of radiation that enters a high-absorption object region in the simulated projection image; and derive a corrected simulated projection image by adding the scattered ray component to the high-absorption object region of the simulated projection image.

### CROSS-REFERENCE TO RELATED APPLICATION

The present application claims priority from Japanese Patent Application No. 2025-052704, filed on Mar. 26, 2025, the entire disclosure of which is incorporated herein by reference.

### BACKGROUND

### Technical Field

The present disclosure relates to an image generation device, an image generation method, and an image generation program.

### Related Art

In a computed tomography (CT) apparatus, in a case in which an object with high X-ray absorption, such as metal, is present within a subject, artifacts attributable to the high-absorption object occur in a reconstructed CT image. Such artifacts interfere with clinical diagnosis. Therefore, various methods for removing the artifacts have been proposed. For example, JP2024-052558A proposes a method of simulating a metal artifact caused by metal included in a CT image to generate a composite artifact, combining the composite artifact with the CT image to simulate a CT image for training, and constructing a machine learning model that removes an artifact from an input CT image using the generated CT image for training.

Meanwhile, in a CT image of a subject including a high-absorption object such as metal, a scattered ray component of X-rays from outside a path is included on a path of X-rays transmitted through the high-absorption object, in addition to the artifact. Therefore, in a case of simulating the CT image for training, it is necessary to consider the scattered ray component that enters from outside the path on the path of the X-rays transmitted through the high-absorption object.

As a method of obtaining the scattered ray component, the Monte Carlo method is known. The Monte Carlo method, which treats X-rays as an ensemble of light quanta (photons), is a technique for simulating the paths by which individual X-ray photons reach a detector. In the Monte Carlo method, for example, the subject is irradiated with on the order of tens of thousands of X-ray photons, and the path of each—as it undergoes physical processes such as absorption and scattering—is tracked individually to probabilistically compute the scattered ray component. By using such a Monte Carlo method, the scattered ray component that enters the path of the X-rays transmitted through the high-absorption object such as the metal can be derived. Therefore, by adding the derived scattered ray component to the image generated by simulation, the projection image for training that also considers the scattered ray component can be simulated.

However, the calculation for each X-ray photon is very time consuming.

### SUMMARY OF THE INVENTION

The present disclosure has been made in view of the above circumstances, and an object of the present disclosure is to derive a simulated projection image including a scattered ray component entering a path of X-rays passing through a high-absorption object such as metal in a short time.

The present disclosure relates to an image generation device comprising: a processor configured to: acquire a simulated projection image that simulates a projection image acquired by imaging a subject including a high-absorption object using a CT apparatus; estimate a scattered ray component representing a scattered ray amount of radiation that enters a high-absorption object region in the simulated projection image; and derive a corrected simulated projection image by adding the scattered ray component to the high-absorption object region of the simulated projection image.

In the image generation device according to this embodiment, the processor may be configured to derive the scattered ray component using an approximate expression based on a projection width of the high-absorption object, a tissue surrounding the high-absorption object, and a distance between the high-absorption object and a detector. The projection width refers to, for example, a width of a structure on the projection image acquired by imaging a structure of the high-absorption object using the CT apparatus.

In the image generation device according to this embodiment, the processor may be configured to derive the scattered ray component using a calculation table that is derived in advance and that defines a relationship between a projection width of the high-absorption object, a tissue surrounding the high-absorption object, and a distance between the high-absorption object and a detector.

The present disclosure relates to an image generation method comprising: acquiring a simulated projection image that simulates a projection image acquired by imaging a subject including a high-absorption object using a CT apparatus; estimating a scattered ray component representing a scattered ray amount of radiation that enters a high-absorption object region in the simulated projection image; and deriving a corrected simulated projection image by adding the scattered ray component to the high-absorption object region of the simulated projection image.

The present disclosure relates to an image generation program causing a computer to execute: a procedure of acquiring a simulated projection image that simulates a projection image acquired by imaging a subject including a high-absorption object using a CT apparatus; a procedure of estimating a scattered ray component representing a scattered ray amount of radiation that enters a high-absorption object region in the simulated projection image; and a procedure of deriving a corrected simulated projection image by adding the scattered ray component to the high-absorption object region of the simulated projection image.

The technology disclosed herein may be applied to a program product.

According to the present disclosure, the simulated projection image including the scattered ray component that enters the path of the X-rays transmitted through the high-absorption object such as the metal can be derived in a short time.

### BRIEF DESCRIPTION OF THE DRAWINGS

FIG. 1 is a schematic configuration diagram of a medical information system including an image generation device according to an embodiment of the present disclosure.

FIG. 2 is a diagram illustrating a hardware configuration of the image generation device according to this embodiment.

FIG. 3 is a diagram illustrating a functional configuration of the image generation device according to this embodiment.

FIG. 4 is a diagram illustrating derivation of a simulated projection image.

FIG. 5 is a diagram illustrating simulated projection data.

FIG. 6 is a diagram illustrating a scattered ray component.

FIG. 7 is a diagram illustrating estimation of the scattered ray component.

FIG. 8 is a diagram illustrating estimation of the scattered ray component.

FIG. 9 is a diagram illustrating estimation of the scattered ray component.

FIG. 10 is a diagram illustrating estimation of the scattered ray component.

FIG. 11 is a diagram illustrating corrected simulated projection data.

FIG. 12 is a flowchart illustrating a process performed in this embodiment.

### DETAILED DESCRIPTION

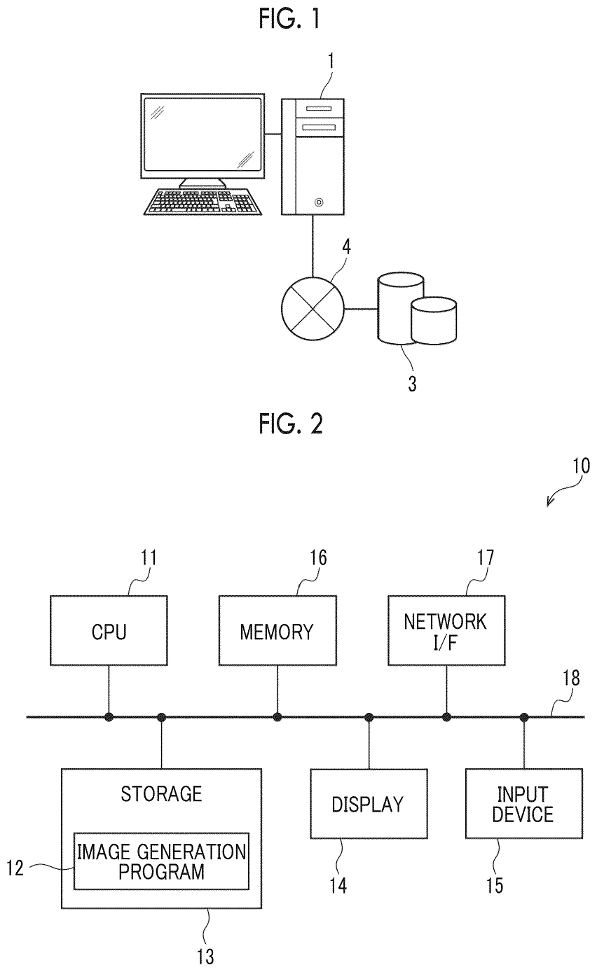

Hereinafter, an embodiment of the present disclosure will be described with reference to the drawings. First, a configuration of a medical information system to which an image generation device according to this embodiment is applied will be described. FIG. 1 is a diagram illustrating a schematic configuration of the medical information system. In the medical information system illustrated in FIG. 1, a computer 1 including the image generation device according to this embodiment and an image storage server 3 are connected to each other via a network 4 in a communicable state.

The computer 1 includes the image generation device according to this embodiment, and an image generation program according to this embodiment is installed. The computer 1 may be a workstation or a personal computer or may be a server computer connected to the workstation or the personal computer through the network. The image generation program is stored, in a state accessible from outside, in a storage device of a server computer connected to a network or in network storage, and is downloaded to the computer 1 and installed. Alternatively, the image generation program may be recorded on a recording medium such as a Digital Versatile Disc (DVD) or a Compact Disc Read Only Memory (CD-ROM), distributed, and installed into the computer 1 from the recording medium.

The image storage server 3 is a computer that stores and manages various data, and includes a large-capacity external storage device and database management software. The image storage server 3 communicates with another device via a wired or wireless network 4, and transmits and receives the image data and the like to and from the other device. For example, various data including simulated projection data, which is image data representing a simulated projection image described later, are acquired via the network and stored and managed in a recording medium such as the large-capacity external storage device.

Next, the image generation device according to this embodiment will be described. FIG. 2 is a diagram illustrating a hardware configuration of the image generation device according to this embodiment. As illustrated in FIG. 2, the image generation device 10 includes a central processing unit (CPU) 11, a non-volatile storage 13, and a memory 16 as a temporary storage area. The image generation device 10 includes a display 14 such as a liquid crystal display, an input device 15 such as a keyboard or a mouse, and a network interface (I/F) 17 connected to the network 4. The CPU 11, the storage 13, the display 14, the input device 15, the memory 16, and the network I/F 17 are connected to the bus 18. The CPU 11 is an example of a processor of the present disclosure.

The storage 13 is realized by a hard disk drive (HDD), a solid state drive (SSD), a flash memory, and the like. An image generation program 12 is stored in the storage 13, which serves as a storage medium. The CPU 11 reads out the image generation program 12 from the storage 13, loads the image generation program 12 into the memory 16, and then executes the loaded image generation program 12.

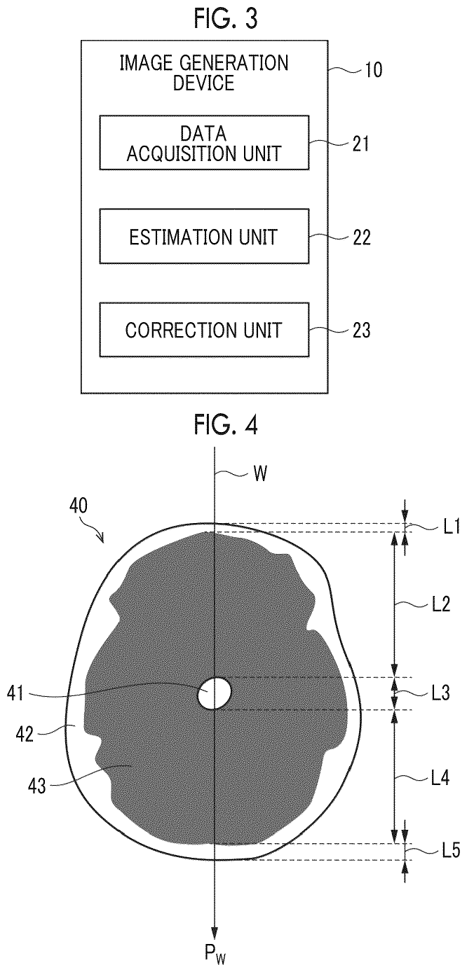

Next, a functional configuration of the image generation device according to this embodiment will be described. FIG. 3 is a diagram illustrating a functional configuration of the image generation device according to this embodiment. As illustrated in FIG. 3, the image generation device 10 includes a data acquisition unit 21, an estimation unit 22, and a correction unit 23. The CPU 11 executes the image generation program 12 to function as the data acquisition unit 21, the estimation unit 22, and the correction unit 23.

The data acquisition unit 21 acquires the image data of the simulated projection image from the image storage server 3. FIG. 4 is a diagram illustrating the generation of the simulated projection image. Here, the generation of the simulated projection image that simulates the projection image acquired by imaging the subject including metal 41, which is a high-absorption object, at the center of a head 40 using a CT apparatus will be described. As illustrated in FIG. 4, in a certain tomographic plane in the head 40 of the subject, a projection value Pw on a transmission path W0 of the X-rays can be represented by Expression (1) using a transmission length L1 of a bone 42 on the transmission path W0, a transmission length L2 of a brain parenchyma 43, a transmission length L3 of the metal 41, a transmission length L4 of the brain parenchyma 43, a transmission length L5 of the bone 42, an attenuation coefficient μb of the bone 42, an attenuation coefficient μs of the brain parenchyma 43, and an attenuation coefficient μm of the metal 41.

$$Pw = exp \{ - μ b \times L 1 + μ s \times L 2 + μm \times L 3 + μs \times L 4 + μ b \times L 5 \} \qquad ( 1 )$$

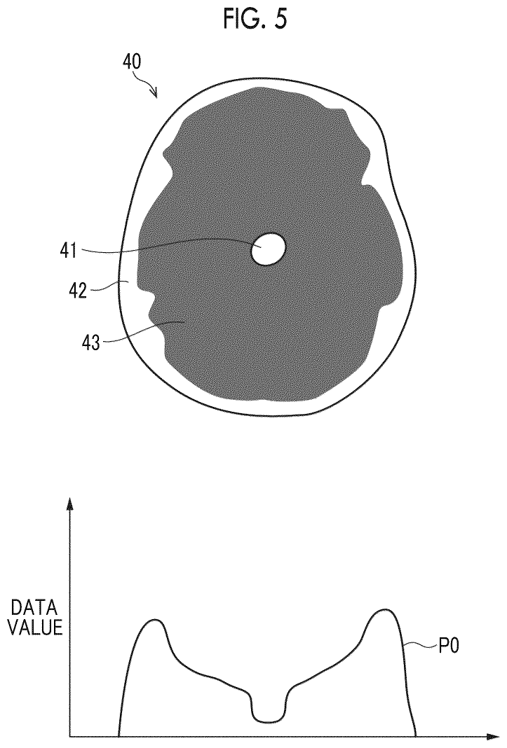

By obtaining Expression (1) over the entire width of the brain, simulated projection data P0 in a certain cross section of the brain can be derived as illustrated in FIG. 5. In addition, a two-dimensional image represented by a set of the simulated projection data P0 in all the cross sections of the brain is the simulated projection image.

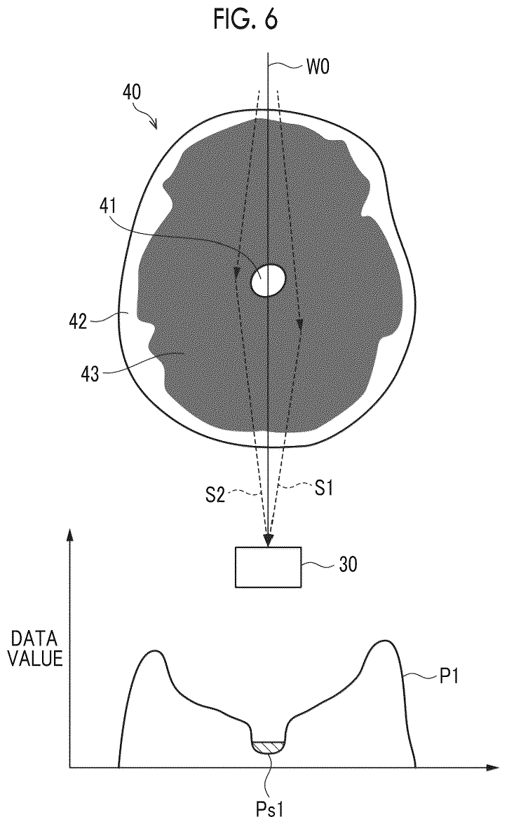

However, in a case of imaging an actual subject, as illustrated in FIG. 6, in addition to direct X-rays that reach a detector 30 in a straight line from a source, scattered ray components S1 and S2 that are scattered by the tissue inside the subject are included in the X-rays. Therefore, a scattered ray component Ps1 is included in a metal region, which is a region in which the metal is projected, in projection data P1 actually acquired.

The image generation device 10 according to this embodiment adds the scattered ray component to the simulated projection image represented by the simulated projection data P0. Therefore, the estimation unit 22 estimates a scattered ray component Ps that enters the metal region in which the metal is projected, in the simulated projection data P0. In this embodiment, the estimation unit 22 estimates the scattered ray component Ps for each channel of the detector 30 using a distance between each channel of the detector 30 provided in the CT apparatus 2 and the metal.

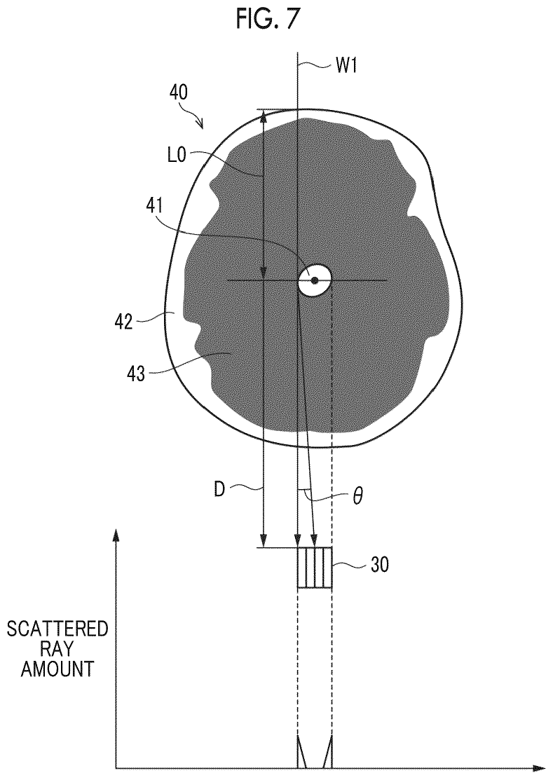

FIG. 7 is a diagram illustrating the estimation of the scattered ray component. In FIG. 7, a position of the metal 41 is a centroid position of the metal 41. First, in a certain transmission path W1 of the X-rays, a dose Iin′ immediately before scattering is derived using Expression (2). In Expression (2), Iin is an X-ray dose emitted from the X-ray source, exp(−μL0) is attenuation of the X-rays due to a transmission length L0 of the X-rays between a subject surface and a position of the metal, and μ is an attenuation coefficient of the tissue at the transmission length L0.

$${Iin}^{′} = Iin \times exp ( - μL 0 ) \qquad ( 2 )$$

A scattered ray amount S0 at a boundary between the metal and the brain parenchyma is derived using Expression (3). K is a probability that the X-rays that travel straight are scattered rays. The probability K is obtained in an angle range of a scattering angle (0 degrees to θmax). Since it is difficult to strictly calculate the probability K, the probability K may be experimentally calculated in advance using a simulation of a phantom simulating the subject or a pencil beam, or the like.

$$S 0 = {Iin}^{′} \times K ( θ ) \qquad ( 3 )$$

The probability K can be approximately calculated using Expression (4), for example, based on a result of the pencil beam simulation. In Expression (4), θ is a scattering angle, and A and B are device-specific parameters, and can be, for example, A=20 and B=0.

$$K ( θ ) = ( 1 / ( 1 + {( θ / A )}^{2} ) ) \cdot ( 1 + B \cdot {θ}^{2} ) \qquad ( 4 )$$

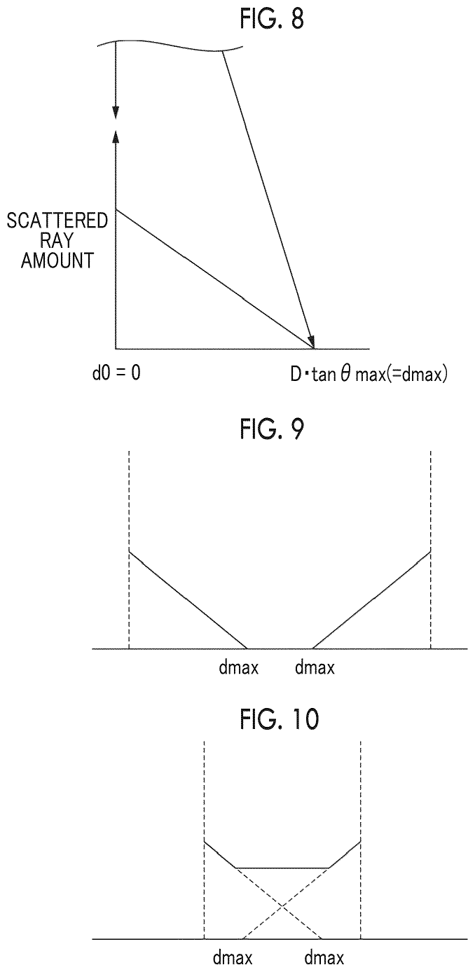

As illustrated in FIG. 8, a boundary position between a region in which the metal is projected and a region in which the brain parenchyma is projected on the detector 30 is defined as d0 (=0). A maximum distance dmax from the boundary position d0 of the scattered ray that enters the region in which the metal is projected from the boundary between the metal and the brain parenchyma on the detector 30 is geometrically derived using Expression (5). In Expression (5), D is a distance from the position of the metal to the detection surface of the detector 30, and θmax is a maximum scattering angle. In FIG. 8, the maximum distance dmax from the boundary position d0 on the left side of the region in which the metal is projected is illustrated, but the maximum distance dmax from the boundary position d0 of the scattered ray that enters the region in which the metal is projected can be calculated by similarly defining the boundary position d0 on the right side of the metal.

$$dmax = D \times tanθmax \qquad ( 5 )$$

Based on Expressions (2) to (5), a scattered ray amount S(c) in a certain channel c of the detector 30 can be calculated using Expression (6). In Expression (6), Sd0 is a scattered ray amount at a boundary of the region in which the metal is projected, and d is a distance from the boundary of the region in which the metal is projected (0≤d≤dmax). Expression (6) represents a scattered ray amount near the boundary on the left side of the metal, but the scattered ray amount S(c) can be similarly calculated at the boundary on the right side of the metal. In addition, the scattered ray component Ps can be derived by deriving S(c) in all the channels c of the detector 30 corresponding to the metal region.

$$S ( c ) = Sd 0 - Sd 0 / dmax \cdot d \qquad ( 6 )$$

As illustrated in Expression (6), as the distance D between the metal and the detector 30 becomes smaller, the distance d from the boundary between the metal and the brain parenchyma to the region of the metal becomes smaller, so that the scattered ray amount becomes smaller. On the contrary, as the distance D between the metal and the detector 30 becomes larger, the distance d from the boundary between the metal and the brain parenchyma to the region of the metal becomes larger, so that the scattered ray amount becomes larger.

In addition, since the attenuation coefficient μvaries depending on the tissue surrounding the metal, the scattered ray amount varies depending on the tissue surrounding the metal.

Further, since the maximum scattering angle θmax is constant, in a case in which the projection width of the metal projected onto the detector 30 becomes large, the distance between the left and right boundaries between the metal and the brain parenchyma becomes large. Therefore, as illustrated in FIG. 9, the overlapping amount of the maximum distance dmax of the scattered rays that go around the left and right boundaries of the metal region becomes small or the overlapping does not occur at all. As a result, the scattered ray amount near the center in the region of the metal is reduced. On the contrary, in a case in which the projection width of the metal projected onto the detector 30 becomes small, the distance between the left and right boundaries between the metal and the brain parenchyma becomes small. Therefore, as illustrated in FIG. 10, the overlapping amount of the maximum distance dmax of the scattered rays that enter the metal region from the left and right boundaries of the metal region becomes large, and as a result, the scattered ray amount near the center in the region of the metal becomes large.

In this embodiment, the scattered ray amount S(c) calculated using Expression (6) based on the distance D between the metal and the detector 30, the attenuation coefficient of the tissue surrounding the metal, and the projection width of the metal is estimated as the scattered ray component Ps.

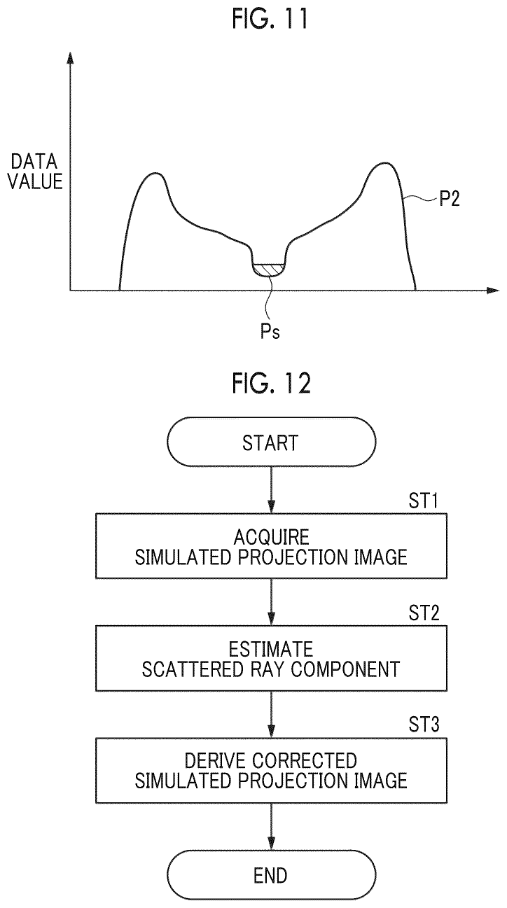

The correction unit 23 adds the scattered ray component Ps estimated by the estimation unit 22 to the metal region of the simulated projection data P0. As a result, as illustrated in FIG. 11, corrected simulated projection data P2 including the scattered ray component Ps is derived. An image represented by the set of the corrected simulated projection data P2 in the entire cross section of the brain is the corrected simulated projection image.

The corrected simulated projection image derived in this way is reconstructed into a tomographic image, and is used for training a derivation model that outputs a tomographic image in which the artifact has been removed in a case in which, for example, a tomographic image including the artifact and acquired by imaging a subject including the metal is input.

Hereinafter, a process performed in this embodiment will be described. FIG. 12 is a flowchart illustrating the process performed in this embodiment. First, the data acquisition unit 21 acquires the simulated projection image from the image storage server 3 (step ST1). Then, the estimation unit 22 estimates the scattered ray component representing the scattered ray amount in the metal region of the simulated projection image (step ST2). Next, the correction unit 23 derives the corrected simulated projection image by adding the scattered ray component to the metal region of the simulated projection image (step ST3), and the process ends.

As described above, in this embodiment, the scattered ray component representing the scattered ray amount of the radiation that enters the high-absorption object region in the simulated projection image is estimated, and the corrected simulated projection image is derived by adding the scattered ray component to the high-absorption object region of the simulated projection image. Therefore, the scattered ray component can be estimated with a small amount of calculation as compared with a method of obtaining the scattered ray component for each photon by the Monte Carlo method and the like. Accordingly, the simulated projection image including the scattered ray component that enters the path of the X-rays transmitted through the metal can be derived in a short time.

In addition, since the simulated projection image including the scattered ray component can be derived in a short time, it is possible to create training data used for training a learning model that performs the process using the simulated projection image in a short time. Therefore, it is possible to prepare an amount of training data, which is sufficient for training in a short time.

In the above embodiment, the estimation unit 22 estimates the scattered ray component using the approximate expression, but the present disclosure is not limited to this. The scattered ray component may be estimated using a calculation table derived in advance to estimate the scattered ray component. The calculation table is created by, for example, measuring the scattered ray component using a phantom that simulates a human body. In this case, as in a case of deriving Expression (6), the calculation table may be created in accordance with various combinations of the X-ray dose, the attenuation coefficient of the tissue that simulates the human body, the distance between the metal and the detector, and the projection width of the metal.

In addition, the calculation table may be created in accordance with various combinations of the X-ray dose, the attenuation coefficient of the tissue that simulates the human body, the distance between the metal and the detector, and the projection width of the metal using Expression (6) instead of the measurement. Here, a collimator for cutting the scattered ray component varies depending on the imaging apparatus to be used. For example, there is a collimator that cuts only a channel direction of the detector and a collimator that cuts channel and column directions of the detector. Therefore, the maximum scattering angle θmax varies depending on the type of the collimator of the apparatus. In this case, the maximum scattering angle θmax may be set in advance in accordance with the type of the collimator of the apparatus, and the calculation table may be created using Expression (6) using the set maximum scattering angle θmax.

In the above embodiment, the simulated projection image in which the metal is embedded in the head of the subject is derived, but the present disclosure is not limited to this. Even in a case of deriving the simulated projection image in which the metal is embedded in a part other than the head, the simulated projection image can be corrected by considering the scattered ray component as in the embodiment.

In this embodiment, each processing is executed by any computer. Further, any computer may execute these processes by hardware in the form of a processor, software in the form of a program, or a combination thereof. In such a case, the processor, in cooperation with the program, is configured to execute the various processes of this embodiment and can function as the respective units or means in this embodiment. Moreover, the order in which the processor executes the process is not limited to the order described and may be changed as appropriate. Any computer may be a general-purpose computer, a computer for a specific purpose, a workstation, or another system capable of executing the respective processes.

The processor may be implemented by one or more pieces of hardware, and the type of hardware is not limited. For example, the processor may be implemented by hardware such as a Central Processing Unit (CPU), a Microprocessor Unit (MPU), a programmable logic device such as a Field-Programmable Gate Array (FPGA), a dedicated circuit for executing specific processing such as an Application-Specific Integrated Circuit (ASIC), a Graphics Processing Unit (GPU), or a Neural Processing Unit (NPU). The type of hardware may be a combination of different kinds of hardware. In a case in which the plurality of hardware components are configured to execute one or more processes of a given processor, the plurality of hardware may reside in devices physically separate from one another or in the same device. In any embodiment, the order of processing by the processor is not limited to the order described above and may be changed as appropriate. The hardware may be implemented as electrical circuitry (circuitry) formed by a combination of circuit elements such as semiconductor devices.

The program may be software such as firmware or microcode. The program may also be, for example, a set of program modules, and the respective functions may be realized by processors configured to execute the corresponding functions. The program may be program code or a plurality of code segments stored on one or more non-transitory computer-readable media (for example, storage media or other storage). The program may be stored in a distributed manner across the plurality of non-transitory computer-readable media located in devices that are physically separate from one another. The program code or code segments may represent procedures, functions, subprograms, routines, subroutines, modules, software packages, classes, or any combination of instructions, data structures, or program statements. The program code or code segments may be connected to other code segments or hardware circuits by transmitting and receiving information, data, arguments, parameters, or memory contents.

In addition, in the above embodiment, the image generation program 12 is stored (installed) in the storage 13 in advance, but the present disclosure is not limited to this. The image generation program 12 may be provided in a form recorded on recording media such as a compact disc read-only memory (CD-ROM), a digital versatile disc read-only memory (DVD-ROM), and a universal serial bus (USB) memory. The image generation program 12 may also be in a form downloaded from an external device via a network.

The technology disclosed herein is applicable to any program product. The term “program product” encompasses products in any form for providing a program. For example, the term “program product” encompasses a program provided through a network such as the Internet, and non-transitory computer-readable recording media such as a CD-ROM, a DVD, and a USB memory in which the program is stored.

The supplementary notes of the present disclosure are set forth.

### Supplementary Note 1

An image generation device comprising: a processor configured to: acquire a simulated projection image that simulates a projection image acquired by imaging a subject including a high-absorption object using a CT apparatus; estimate a scattered ray component representing a scattered ray amount of radiation that enters a high-absorption object region in the simulated projection image; and derive a corrected simulated projection image by adding the scattered ray component to the high-absorption object region of the simulated projection image.

### Supplementary Note 2

The image generation device according to supplementary note 1, in which the processor is configured to derive the scattered ray component using an approximate expression based on a projection width of the high-absorption object, a tissue surrounding the high-absorption object, and a distance between the high-absorption object and a detector.

### Supplementary Note 3

The image generation device according to supplementary note 1, in which the processor is configured to derive the scattered ray component using a calculation table that is derived in advance and that defines a relationship between a projection width of the high-absorption object, a tissue surrounding the high-absorption object, and a distance between the high-absorption object and a detector.

### Supplementary Note 4

An image generation method comprising: acquiring a simulated projection image that simulates a projection image acquired by imaging a subject including a high-absorption object using a CT apparatus; estimating a scattered ray component representing a scattered ray amount of radiation that enters a high-absorption object region in the simulated projection image; and deriving a corrected simulated projection image by adding the scattered ray component to the high-absorption object region of the simulated projection image.

### Supplementary Note 5

An image generation program causing a computer to execute: a procedure of acquiring a simulated projection image that simulates a projection image acquired by imaging a subject including a high-absorption object using a CT apparatus; a procedure of estimating a scattered ray component representing a scattered ray amount of radiation that enters a high-absorption object region in the simulated projection image; and a procedure of deriving a corrected simulated projection image by adding the scattered ray component to the high-absorption object region of the simulated projection image.

What is claimed is:

1. An image generation device comprising:
a processor configured to:
acquire a simulated projection image that simulates a projection image acquired by imaging a subject including a high-absorption object using a CT apparatus;
estimate a scattered ray component representing a scattered ray amount of radiation that enters a high-absorption object region in the simulated projection image; and
derive a corrected simulated projection image by adding the scattered ray component to the high-absorption object region of the simulated projection image.

2. The image generation device according to claim 1,
wherein the processor is configured to derive the scattered ray component using an approximate expression based on a projection width of the high-absorption object, a tissue surrounding the high-absorption object, and a distance between the high-absorption object and a detector.

3. The image generation device according to claim 1,
wherein the processor is configured to derive the scattered ray component using a calculation table that is derived in advance and that defines a relationship between a projection width of the high-absorption object, a tissue surrounding the high-absorption object, and a distance between the high-absorption object and a detector.

4. An image generation method comprising:
acquiring a simulated projection image that simulates a projection image acquired by imaging a subject including a high-absorption object using a CT apparatus;
estimating a scattered ray component representing a scattered ray amount of radiation that enters a high-absorption object region in the simulated projection image; and
deriving a corrected simulated projection image by adding the scattered ray component to the high-absorption object region of the simulated projection image.

5. A non-transitory computer-readable storage medium that stores an image generation program causing a computer to execute:
a procedure of acquiring a simulated projection image that simulates a projection image acquired by imaging a subject including a high-absorption object using a CT apparatus;
a procedure of estimating a scattered ray component representing a scattered ray amount of radiation that enters a high-absorption object region in the simulated projection image; and
a procedure of deriving a corrected simulated projection image by adding the scattered ray component to the high-absorption object region of the simulated projection image.
